(19) United States
(12) Patent Application Publication
(10) Pub. No.: US 2017/0032378 A1
(43) Pub. Date: Feb. 2, 2017

(54) HYBRID LICENSE STATE DETERMINATION

(71) Applicant: Microsoft Technology Licensing, LLC, Redmond, WA (US)

(72) Inventors: Piotr A. Ciszewski, Kirkland, WA (US); Daulet Zhanguzin, Bellevue, WA (US)

(21) Appl. No.: 14/883,805

(22) Filed: Oct. 15, 2015

Related U.S. Application Data
(60) Provisional application No. 62/199,379, filed on Jul. 31, 2015.

(51) Int. Cl. G06Q 30/00

(52) U.S. Cl. CPC G06Q 30/018

(57) ABSTRACT

Enhanced licensing technology is disclosed herein. In an implementation, a licensing service provisions license records with license information received from a license provisioning service and indicative of at least a state of each of a plurality of software licenses associated with various users and an operational profile associated with each of various software licenses. License requests are received from various applications for the license information under which to operate the applications. In response to at least one request, the licensing service obtains a current state of the license for an application from the license provisioning service and replies with at least the current state of the license and the operational profile associated with the license as received from the license provisioning service prior to the request.

### RELATED APPLICATIONS

This application is related to and claims priority to U.S. Provisional Patent Application No. 62/199,379, filed on Jul. 31, 2015, and entitled “Hybrid License State Determination,” which is hereby incorporated by reference in its entirety.

### TECHNICAL BACKGROUND

Many software applications upon start-up communicate with online license services to obtain a license for operation. The licensing service typically services the requests made by the applications, returning license keys, keyless authorizations, or other types of license information that may (or may not) allow an application to operate.

In some scenarios, the license services are provisioned with licensing information from a license provisioning service. The license information may include, for example, customer data indicative of the name of a tenant, user identities, and other descriptive information. The license information may also include customer state that is indicative of a state of a license for a particular user, tenant, or the like.

As new licenses are added and existing license information changes, licensing services receive updates from the provisioning services. For instance, when an existing tenant makes changes to its licensing plan, the changes are first recognized in the provisioning service and are later communicated to the licensing service that interacts with client applications. In another example, a new tenant may obtain a new set of licenses for its users, which are also recognized initially in the provisioning service and then communicated to the licensing service. As individual users are added and removed with respect to a license plan, the changes are made first in the provisioning service and then are propagated to the licensing service.

One drawback to this approach involves the time lag involved between state changes that occur in a provisioning service and when a licensing service is updated with the state changes. As a result, new users who have transacted for a valid license to use an application may be prevented from doing using it if the licensing service with which their application is in communication perceives their license state as invalid, expired, or the like.

While this problem can occur with respect to traditional desktop applications and in enterprise situations, a similar problem can occur when licenses are purchased by individuals via app stores. A mobile application may be transacted for in the app store, but provisioning of a user's rights in a licensing service can be delayed. While the app may be successfully installed on a user's device, its full functionality may be inhibited due to delays in updating license state, resulting in a sub-optimal experience for the user.

### Overview

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

Technology is disclosed herein that enhances licensing technology to better determine the state of application licenses. In an implementation, a license service is provisioned from a provisioning service with license information associated with various licenses. The license information includes, for example, the state of each license and operational information for each license.

The provisioning service may periodically update the license service with changes that occur with respect to the license information. To mitigate against the risk that state changes are not propagated in-time, the license service is capable of querying the provisioning service for the state of a license, when an application submits a license request to the license service. The license service obtains the current license state from the provisioning service and can reply to the application with both the current state of the license and the operational information.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational environment in an implementation of hybrid license state determination.

FIG. 2 illustrates a hybrid state process in an implementation.

FIG. 3 illustrates a hybrid state process in an implementation.

FIG. 4 illustrates a hybrid scenario in an implementation.

FIG. 5 illustrates a hybrid scenario in an implementation.

FIG. 6 illustrates a hybrid state process in an implementation.

FIG. 7 illustrates a hybrid scenario in an implementation.

FIG. 8 illustrates a computing system suitable for implementing the enhanced licensing technology disclosed herein, including any of the environments, architectures, elements, processes, and operational scenarios and sequences illustrated in the Figures and discussed below in the Technical Disclosure.

### TECHNICAL DISCLOSURE

Licensing technology is disclosed herein that enhances the state determination process for application license requests. In various implementations, a license service is provisioned with license information from a provisioning service. The license service populates license records with the information, which may include the state of a given license and operational information associated with the license.

Over time, the state of the license may change in the provisioning service, as can the operational information. A background process typically executes to update the license service with such changes in the provisioning service so that, when applications query the license service, the license service can reply with the updated information. However, the background process may be delayed due to high volumes, system problems, or other reasons. When such delays occur, the state of a license maintained by the licensing service may become out-of-date and no longer reflect of the current state of the license.

The licensing service mitigates this risk by communicating with the provisioning service outside of the background process to obtain the current state of a license. This happens when, for instance, the licensing service receives a license request from an application. The licensing service can reply to the license request with the current state of the license just obtained from the provisioning service and with operational information as provisioned earlier by the provisioning service.

In this manner, a technical effect is achieved in that the current state of a license is obtained by the licensing service without having to rely upon an update process that updates license information in the background. The current state of a license may impact how an application runs, such as whether or not it is unlocked, operates in a full-access mode or a limited-access mode, or the like. When customers modify licenses—such as by adding or removing users to a plan, subscribing to an application or service, or adding and removing applications or services from a plan—the impact on license state by the modifications can be immediately fed to the licensing service. Other customer information that changes may be updated via the background process, such as tenant identifies, machine information (type, model, etc.), and product identifiers.

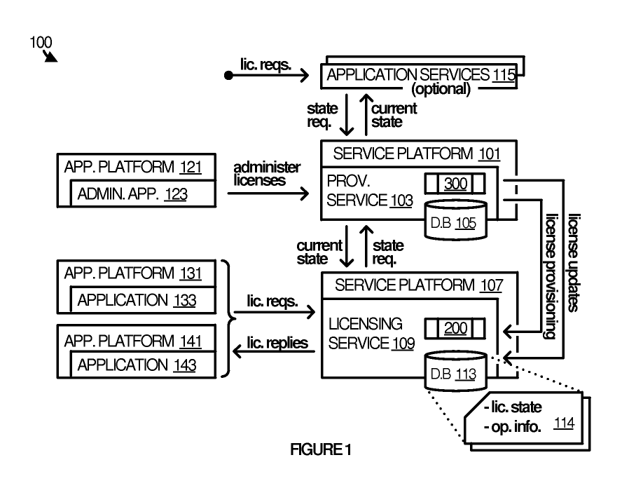

FIG. 1 illustrates an operational environment 100 in an implementation of hybrid state determination. Operational environment 100 includes service platform 101 and service platform 107, which host provisioning service 103 and licensing service 109 respectively. Operational environment 100 optionally includes application service 115.

Provisioning service 103 is representative of any software service through which end-users (such as users, customers, or administrative personnel, including third parties) may administer software licenses. As an example, administrative application 123 running on application platform 121 may be utilized by personnel to administer licenses through provisioning service 103. The users may, for example, purchase new licenses, add or remove users from a volume licensing plan, add or remove software products from a plan, or otherwise modify an associated license or licenses.

Provisioning service 103 communicates with licensing service 109 to provision license information that reflects the various licenses administered by customers or third-parties. As licenses are transacted for, license records are created or modified in provisioning service 103 that then must be loaded in licensing service 109. Database 105 is representative of a data store in provisioning service 103 that may store such licensing information.

Licensing service 109 is representative of any software service capable of being provisioning by provisioning service 103 and that communicates with applications in the context of licensing operations. Application 133 and application 143, hosted on application platform 131 and application platform 141 respectively, are representative of such applications that may communicate with licensing service 109 to obtain a license and/or license information. Examples of applications 133 and 143 include, but are not limited to, productivity applications, gaming applications, business applications, personal information management applications, mobile applications, and any other kind of application, variation, or combination thereof.

Licensing service 109 stores license information provided by provisioning service 103 in database 113. Database 113 is representative of any data store that may store license information. Record 114 is representative of just one license record that may be stored in database 113. Record 114 includes license information representative of a license state associated with a license and operational information associated with the license. Other license information is possible and may be considered within the scope of this disclosure.

Application service 115 is representative of any hosted or online application service that may communicate with provisioning service 103 to obtain license information. Examples of application service 115 include, but are not limited to, productivity services (online versions of desktop productivity software), gaming services, business software services, online communication services, and the like. Users may access application service 115 via web browser applications or other similar portals. In contrast, applications 133 and 143 are representative of applications that may run natively with respect to a user's device.

Service platform 101 and service platform 107 are each representative of any physical or virtual computing system or collection thereof suitable for hosting provisioning service 103 and licensing service 109. While shown as implemented on separate service platforms, the services could be implemented on a single service platform. Computing system 801 illustrated in FIG. 8 is representative of one such computing system.

In operation, personnel administer licenses via administrative application 123. Administrative application 123 may be a stand-alone application or service or may be integrated in the context of another application or service. For instance, administrative application 123 may run in the context of a web-browser or may be a native application.

Administering the licenses may include, for example, adding and removing users, adding and removing applications, or modifying any combination of users and applications. New license records may be created in database 105 and then newly-provisioned in database 113. Record modifications may also be made in database 105 and database 113 updated to reflect the same.

Both the provisioning and updating processes may occur periodically, in batch-mode, in real-time as much as it is possible, or at some other interval. However, customer loads placed on provisioning service 103 can lead to delays in provisioning new records or updating existing records. Licensing service 109 mitigates this risk by obtaining the current state of licenses in real-time from provisioning service 103, out-of-band with respect to any provisioning or update processes occurring in the background.

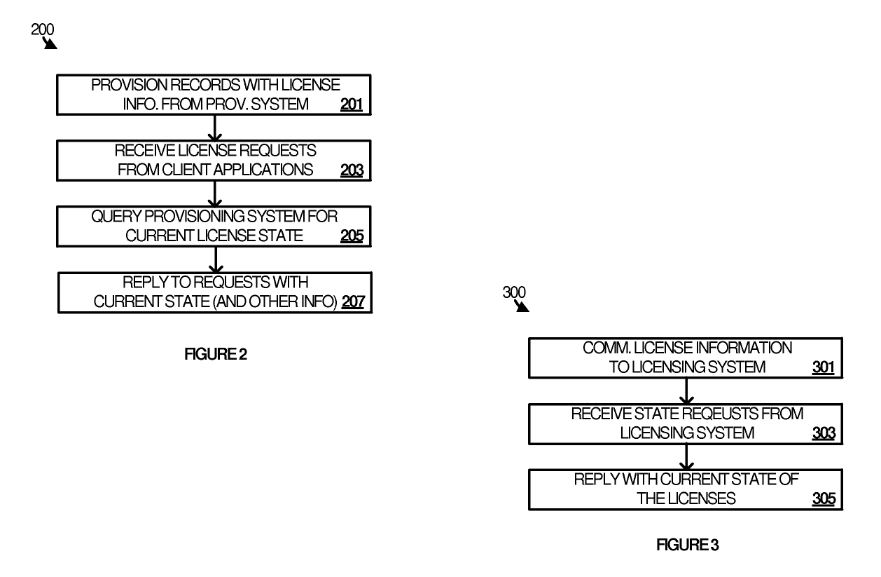

In particular, licensing service 109 employs a hybrid state process 200 to provide enhanced licensing services to applications. Hybrid state process 200 is representative of any software component, module, application program interface (API), or combination of elements implemented in program instructions for carrying out the related functionality illustrated in FIG. 2. The following therefore refers parenthetically to the steps enumerated in FIG. 2. Other steps in addition to those disclosed are possible.

In operation, licensing service 109 receives license information from provisioning service 103 as part of a provisioning process for license records (step 201). The records are stored in database 113 (or any other suitable data store) and are periodically updated by provisioning service 103.

At various other times, licensing service 109 receives license requests from applications, in order for the applications to operate under the terms of a given license (step 203). While records may exist in database 113, they are not necessarily current, in that the current state of a given license may not be reflected yet. Accordingly, licensing service 109 responsively queries provisioning service 103 for the current state of a given license for each request (step 205). Once the current state has been obtained, licensing service 109 generates a reply that is indicative of at least the current state of the license (just obtained) and at least some of the operational information earlier provisioned or updated by provisioning service 103 (step 207). The applications receive the replies and their internal license logic operates on the current state and the operational information to drive the application per its license. Examples of different license states include valid, invalid, paid, unpaid, recently paid, recently unpaid, under trial, time limited, and revoked, as well as any other possible state.

FIG. 3 illustrates a different process, hybrid state process 300, employed by provisioning service 103 to provide enhanced licensing to applications. Hybrid state process 300 is representative of any software component, module, APLI, or combination of elements implemented in program instructions for carrying out the relative functionality illustrated in FIG. 3. The following operational discussion therefore makes parenthetical reference to the steps illustrated in FIGS. 2 and 3 with respect to hybrid state processes 200 and 300.

In operation, provisioning service 103 communicates license information to licensing service 109 (step 301). This may occur in the context of newly-provisioning records, updating existing records, or any variation or combination thereof.

At any given time, provisioning service 103 may receive a request for the current state of a license from licensing service 109 (step 303). Provisioning service 103 responsively looks up the current state of the license in database 105 and replies to licensing service 109 with the information (step 305).

It may be appreciated that hybrid state process 200 and hybrid state process 300 need not be carried out on each and every license request. Rather, the processes may be enabled or disable selectively on a per-user basis, a per-tenant basis, a per-application basis, or any variation or combination thereof. When not enabled, licensing service 109 would service a license request using the latest state recorded in database 113 for a license.

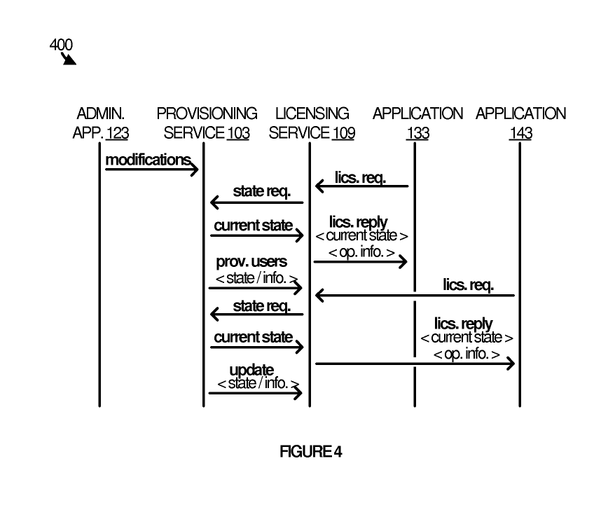

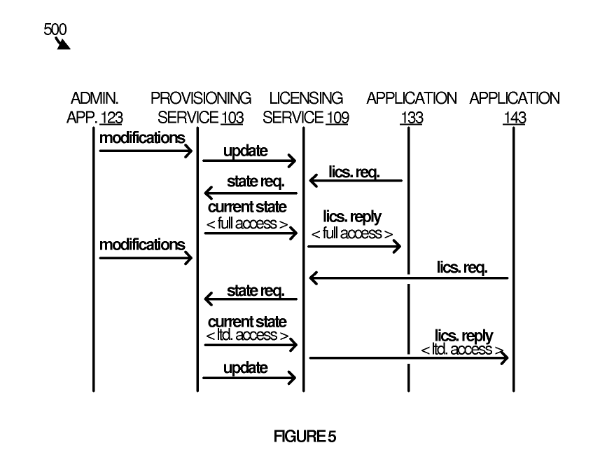

FIG. 4 illustrates an operational scenario to better highlight some aspects of the enhanced licensing technology disclosed herein. In operation, modifications are made to one or more license records in provisioning service 103 by administrative application 123. At some point after the modifications are made, a license request is communicated by application 133 to licensing service 109.

Licensing service 109 responsively queries provisioning service 103 for the current state of the license associated with application 133 (or its user). Provisioning service 103 replies with the current state, which is then returned by licensing service 109 to application 133. The reply by licensing service 109 includes both the current state of the license and operational information already maintained by licensing service 109. Application 133 then proceed to operate in accordance with the license.

In the meantime, the modifications made earlier are eventually provisioned in licensing service 109, which may include provisioning new records. Another licensing request is then received from application 143. Licensing service 109 obtains the current state of the license for application 143 and replies to the request with the current state and operational information. Application 143 proceeds to operate in accordance with the terms of the license.

It may be appreciated from the operational scenario in FIG. 4 that the current state of a license for application 133 can be obtained, even though a license record has not yet been provisioned (in full or in part) in licensing service 109. In addition, even though such license information has been provisioned by the time application 143 submits a license request, checking with provisioning service 103 out-of-band guarantees that the current state of the license is obtained, rather than using state that has possibly changed.

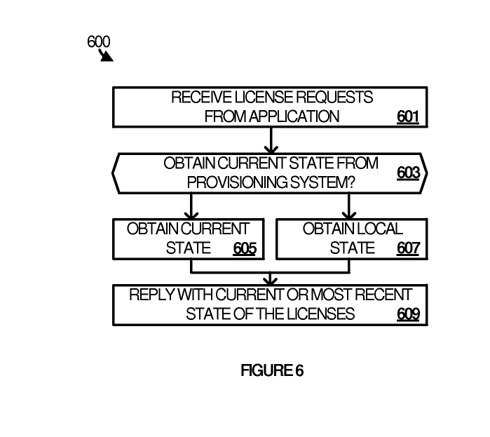

FIG. 5 illustrates another operational scenario in an implementation. In operation, licenses modifications are made via administrative application 123 to license information in provisioning service 103. Provisioning service 103 responsively updates licensing service 109 with the modifications. It may be assumed for exemplary purposes that the current state of the licenses for both application 133 and application 143 at this time are such that users are granted full-access to each application (e.g. valid, paid).

In time, application 133 submits a license request to licensing service 109. Licensing service 109 responsively obtains a current state for the license associated with application 133 from provisioning service 103. In this example, it is assumed that the license state indicates full-access for application 133. Accordingly, licensing service 109 replies to application 133 with the current state (full-access) and operational information for the licensing logic contained therein to consume.

Later on, additional modifications are made to the licensing information in provisioning service 103. However, provisioning service 103 is unable to communicate an update to licensing service 109 before a new license request is received. It is assumed for exemplary purposes that the modifications result in the license to application 143 being revoked. However, since an update is not accomplished, the state of the license as maintained by licensing service 109 would be the valid and paid state provisioned earlier.

Licensing service 109 receives the license request from application 143 and obtains the current state of the license from provisioning service 103. It is assumed in this example that the current state is one that results in limited access to application 143 as modified earlier in provisioning service 103. Eventually the modifications may be updated in licensing service 109 such that its state matches that in provisioning service 103.

FIG. 6 illustrates another hybrid state process 600 that may be employed by a licensing service, such as licensing service 109. Some implementations of licensing service 109 may include the ability to dynamically enable and disable hybrid state determination on a per-user, per-tenant, or per-application property basis, or for some other reason. The functionality could be turned off globally such that licensing service 109 always refrains from query provisioning service 103 for the current state of a license. However, the functionality could be determined on a per-request basis, as illustrated in FIG. 6.

Referring parenthetically to the steps in FIG. 6, licensing service 109 in operation receives license requests from applications (step 601) and makes a determination (Step 603) about whether or not to obtain current state from provisioning service 103. The hybrid state determination processes may be enabled and disabled for a variety of reasons. For example, an operator of the licensing service may enable hybrid state determinations for specific tenants in a service environment or for specific application properties.

If yes, then licensing service 109 communicates with provisioning service 103 to obtain the current state of the service. If no, the licensing service 109 retrieves the most recent state that it has stored locally (step 607). In either case, licensing service 109 then replies to the client with either the current state of the license for that application or the most recent state that it has maintained (step 609).

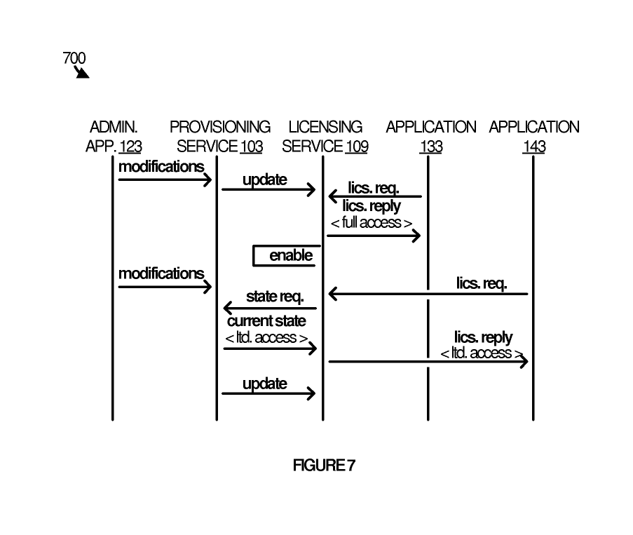

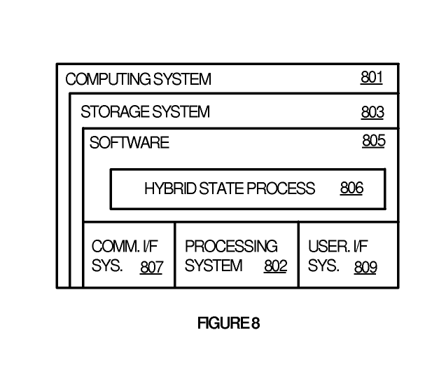

FIG. 7 illustrates another operational sequence related to the hybrid state determination process illustrated in FIG. 6. It is assumed in this example, that hybrid state determination is initially disabled.

In operation, license modifications are made via administrative application 123 and are stored in provisioning service 103. Provisioning service 103 updates licensing service 109 with the modifications.

Licensing service 109 may receive a license request from application 133, in response to which it identifies a most recent state of the license from a local data store that it maintains. This is because the hybrid process is initially disabled.

However, the hybrid process may eventually be enabled for the tenant, application property, or user associated with applications 133 and 143. As such, when application 143 communicates a license request, licensing service 109 obtains the current state of the license from provisioning service 103.

Moreover, additional modifications were received via administrative application 123 prior to the license request by application 143, but the modifications were not propagated to licensing service 109. It is assumed for exemplary purposes that the modifications were to remove or otherwise invalidate the license for application 143. Without the hybrid process being enabled, application 143 would have been supplied with invalid state information by licensing service 109.

One example of licensing service 109 the Office Licensing Service (OLS), which is a cloud service that activates Office 365® clients. It is a “workload” of Office 365® which means that it needs to discover the information about all tenants (i.e. companies) and users (i.e. employees of the companies) who have the Office 365® client license assigned. This information is needed so that, when individual users request an Office® license, the service can accept or deny the license request, based on the status of the user and their tenant in the Office 365® management system.

OLS obtains the information from the Azure Active Directory (AAD) system. This system contains the latest information about all tenants and users and the licenses they currently have. Problematically, OLS uses a piece of AAD infrastructure called “Forward Sync” (FS); using background processes, OLS pulls information about all new tenants/users as well as all changes to existing tenants/users. Thus OLS needs to create and maintain a copy of the licensing state from AAD in order to issue licenses for a given tenant and user. However, this can lead to lengthy delays in the provisioning of new customers if other changes are pending in the Forward Sync queue. Certain Office 365® scenarios require instant provisioning from the time a tenant or user signs up to the tenant or user being able to obtain a license.

Due to complexity of synching, it is very likely that the copy of data in OLS will diverge from the original data in the source of truth (AAD) over item. To solve these and other problems, OLS exposes web APIs that are called by both Office client software (to obtain licenses) as well as by partner systems to discover current customer state. Those APIs rely on the tenant/user state stored locally in OLS—that state is a copy of the AAD state with additional OLS data attached to it.

The solution is a hybrid model where for certain customer critical APIs OLS will not rely only on its latest copy of the state but will in real-time call into Azure Active Directory (AAD) to discover new costumer state or changes to state. At the same time OLS still uses Forward Sync to pick up the less important changes, in the background.

A key component of the solution is a data access component that is used by all OLS API code. It abstracts away the hybrid nature of provisioning from all developer code allowing for a smooth transition from the old model to the hybrid model and then to the fully real-time model without the need to update the existing API code base.

A technical effect of the hybrid solution is the fact that it offers a gradual, controlled evolution from: 1) workloads that use a background provisioning process to pick up customer data and changes using a “sync approach”, to 2) workloads that query a central source of truth in real time to service customer requests, and potentially cache the data. It allows certain OLS APIs to be gradually exposed to the second approach while still relying on the first approach. A fail over back to the first approach is always possible should the second approach not be practical or reliable.

As mentioned, a key component of the hybrid solution is the abstract data access component. As designed it isolates the business logic code (OLS APIs) from the underlying external data sources. The data access component determines which external data sources it should use to service a particular API request; this behavior is configurable and can enable/disable new sources as necessary. The data access component is responsible for returning the best possible state to the API code. It knows which external sources are available and it knows the priority of each source.

For example, the component may work as follows. Two external sources of customer data are defined: 1) AAD Forward Sync, which is a background, asynchronous process that populates OLS with that latest customer data, with some latency; and 2) a real-time AAD Graph API used to perform just-in-time to queries for latest customer state.

The second source is defined as having top priority. This means that the data access component always tries to get customer data from that source. If data was retrieved from the graph, then merged with any existing state in OLS that was created based on previous calls to either the graph or by the background process using the first source. If the graph was not available, then only existing data in OLS is used, which may have come from the first source.

The API code calling into the data access component always gets an actual real record existing in OLS but it never knows, or needs to know, if that state existed before the request or if it was generated just in time, as the result of the request into the data access component.

FIG. 8 illustrates computing system 801 that is representative of any system or collection of systems in which the various applications, services, scenarios, and processes disclosed herein may be implemented. Examples of computing system 801 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes hybrid state process 806, which is representative of the processes discussed with respect to the preceding FIGS. 1-8, including hybrid state process 200, 300, and 600. When executed by processing system 802 to enhance service validation, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions and among other functions may, when executed by processing system 802, direct processing system 802 to operate as described with respect to the various operational scenarios, sequences, and processes illustrated herein. For example, software 805 may include program instructions for implementing enhanced service validation.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtual machine software, or other application software, in addition to or that include hybrid state process 806. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to facilitate enhanced service validation. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

### Example 1

A method of operating a licensing service comprising: provisioning a plurality of license records with license information received from a license provisioning service and indicative of at least a state of each of a plurality of software licenses associated with a plurality of users and an operational profile associated with each of the plurality of software licenses; receiving a plurality of license requests from a plurality of applications for the license information under which to operate the plurality of applications; and in response to at least one request of the plurality of license requests, obtaining a current state of the license for an application from the license provisioning service and replying with at least the current state of the license and the operational profile associated with the license as received from the license provisioning service prior to the request.

### Example 2

The method of example 1 further comprising receiving periodic updates to the license information indicative of at least an updated state of at least some of the plurality of software licenses.

### Example 3

The method of examples 1-2 wherein obtaining the current state of the license occurs irrespective of any of the updates to the license information.

### Example 4

The method of examples 1-3 wherein the periodic updates to the license information are further indicative of an updated operational profile for at least some of the plurality of software licenses.

### Example 5

The method of examples 1-4 wherein the operational profile associated with each of the plurality of software licenses is indicative of at least a tenant associated a given software license, a license type associated with the given software license, and a user associated with the given software license.

### Example 6

The method of examples 1-5 further comprising selectively enabling the licensing service to obtain the current state of the license on a per-tenant basis.

### Example 7

The method of examples 1-6 further comprising selectively enabling the licensing service to obtain the current state of the license on a per-application basis.

### Example 8

The examples of examples 1-7 wherein the plurality of applications comprise natively installed and executed applications.

### Example 9

A computing system for managing licenses comprising: a storage system; a processing system operatively coupled with the storage system; and program instructions stored on the storage system that, when executed by the processing system, direct the processing system to at least: provision a plurality of license records with license information received from a license provisioning service and indicative of at least a state of each of a plurality of software licenses associated with a plurality of users and an operational profile associated with each of the plurality of software licenses; and in response to at least one of a plurality of license requests received from a plurality of applications for the license information under which to operate the plurality of applications, obtain a current state of the license for an application from the license provisioning service and replying with at least the current state of the license and the operational profile associated with the license as received from the license provisioning service prior to the request.

### Example 10

The computing service of example 9 wherein the program instructions further direct the processing service to update the license information with updates received periodically from the provisioning service that indicate at least an updated state of at least some of the plurality of software licenses.

### Example 11

The computing system of examples 9-10 the program instructions direct the processing system to obtain the current state of the license occurs irrespective of any of the updates to the license information.

### Example 12

The computing system of examples 9-11 wherein updates are further indicative of an updated operational profile for at least some of the plurality of software licenses.

### Example 13

The computing system of examples 9-12 wherein the operational profile associated with each of the plurality of software licenses is indicative of at least a tenant associated a given software license, a license type associated with the given software license, and a user associated with the given software license.

### Example 14

The computing system of examples 9-13 further comprising selectively enabling the licensing service to obtain the current state of the license on a per-tenant basis.

### Example 15

The computing system of examples 9-14 further comprising selectively enabling the licensing service to obtain the current state of the license on a per-application basis.

### Example 16

The computing system of examples 9-15 wherein the plurality of applications comprise natively installed and executed applications.

### Example 17

A method of operating a license provisioning service comprising: communicating license information to a licensing service with which to provision a plurality of license records, wherein the licensing information comprises at least a state of each of a plurality of software licenses associated with a plurality of applications and an operational profile associated with each of the plurality of software licenses; periodically updating the license information with at least an updated state of at least some of the plurality of software licenses and an updated operational profile; independent of updating the license information, periodically receiving a plurality of state requests from the licensing service to obtain a current state of at least one of the software licenses associated with at least one of the applications; and responding to the plurality of state requests with the current state.

### Example 18

The method of example 18 further comprising servicing license requests communicated by a plurality of hosted applications.

### Example 19

The method of examples 17-19 wherein the plurality of applications comprise natively installed and executed applications.

### Example 20

The method of examples 17-19 wherein the operational profile associated with each of the plurality of software licenses is indicative of at least a tenant associated a given software license and a license type associated with the given software license.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method of operating a licensing service comprising:
provisioning a plurality of license records with license information received from a license provisioning service and indicative of at least a state of each of a plurality of software licenses associated with a plurality of users and an operational profile associated with each of the plurality of software licenses;
receiving a plurality of license requests from a plurality of applications for the license information under which to operate the plurality of applications; and
in response to at least one request of the plurality of license requests, obtaining a current state of the license for an application from the license provisioning service and replying with at least the current state of the license and the operational profile associated with the license as received from the license provisioning service prior to the request.

2. The method of claim 1 further comprising receiving periodic updates to the license information indicative of at least an updated state of at least some of the plurality of software licenses.

3. The method of claim 2 wherein obtaining the current state of the license occurs irrespective of any of the updates to the license information.

4. The method of claim 3 wherein the periodic updates to the license information are further indicative of an updated operational profile for at least some of the plurality of software licenses.

5. The method of claim 4 wherein the operational profile associated with each of the plurality of software licenses is indicative of at least a tenant associated a given software license, a license type associated with the given software license, and a user associated with the given software license.

6. The method of claim 1 further comprising selectively enabling the licensing service to obtain the current state of the license on a per-tenant basis.

7. The method of claim 1 further comprising selectively enabling the licensing service to obtain the current state of the license on a per-application basis.

8. The method of claim 1 wherein the plurality of applications comprise natively installed and executed applications.

9. A computing system for managing licenses comprising:
a storage system;
a processing system operatively coupled with the storage system; and
program instructions stored on the storage system that, when executed by the processing system, direct the processing system to at least:
provision a plurality of license records with license information received from a license provisioning service and indicative of at least a state of each of a plurality of software licenses associated with a plurality of users and an operational profile associated with each of the plurality of software licenses; and
in response to at least one of a plurality of license requests received from a plurality of applications for the license information under which to operate the plurality of applications, obtain a current state of the license for an application from the license provisioning service and replying with at least the current state of the license and the operational profile associated with the license as received from the license provisioning service prior to the request.

10. The computing service of claim 9 wherein the program instructions further direct the processing service to update the license information with updates received periodically from the provisioning service that indicate at least an updated state of at least some of the plurality of software licenses.

11. The computing system of claim 10 the program instructions direct the processing system to obtain the current state of the license occurs irrespective of any of the updates to the license information.

12. The computing system of claim 11 wherein updates are further indicative of an updated operational profile for at least some of the plurality of software licenses.

13. The computing system of claim 12 wherein the operational profile associated with each of the plurality of software licenses is indicative of at least a tenant associated a given software license, a license type associated with the given software license, and a user associated with the given software license.

14. The computing system of claim 9 further comprising selectively enabling the licensing service to obtain the current state of the license on a per-tenant basis.

15. The computing system of claim 9 further comprising selectively enabling the licensing service to obtain the current state of the license on a per-application basis.

16. The computing system of claim 9 wherein the plurality of applications comprise natively installed and executed applications.

17. A method of operating a license provisioning service comprising:
communicating license information to a licensing service with which to provision a plurality of license records, wherein the licensing information comprises at least a state of each of a plurality of software licenses associated with a plurality of applications and an operational profile associated with each of the plurality of software licenses;
periodically updating the license information with at least an updated state of at least some of the plurality of software licenses and an updated operational profile;
independent of updating the license information, periodically receiving a plurality of state requests from the licensing service to obtain a current state of at least one of the software licenses associated with at least one of the applications; and
responding to the plurality of state requests with the current state.

18. The method of claim 18 further comprising servicing license requests communicated by a plurality of hosted applications.

19. The method of claim 19 wherein the plurality of applications comprise natively installed and executed applications.

20. The method of claim 19 wherein the operational profile associated with each of the plurality of software licenses is indicative of at least a tenant associated a given software license and a license type associated with the given software license.
